(19) United States
(12) Patent Application Publication
(10) Pub. No.: US 2019/0163140 A1
(43) Pub. Date: May 30, 2019

(54) WRISTWATCH WITH HYBRID FLUSH MOUNT BEZEL HAVING FALSE PRONGS

(71) Applicants: Ryan Alvin Wilson, Lakeland, FL (US); Loren Fernandez Wilson, Lakeland, FL (US); Alvin Walter Wilson, JR., Lakeland, FL (US)

(72) Inventors: Ryan Alvin Wilson, Lakeland, FL (US); Loren Fernandez Wilson, Lakeland, FL (US); Alvin Walter Wilson, JR., Lakeland, FL (US)

(21) Appl. No.: 15/823,565

(22) Filed: Nov. 27, 2017

(51) Int. Cl. G04B 47/04; A44C 17/04; G04B 45/00; A44C 17/02

(52) U.S. Cl. CPC G04B 47/042; A44C 17/02; G04B 45/0076; A44C 17/04

(57) ABSTRACT

Some implementations can include a wristwatch comprising a case having a bezel, and a plurality of semispherical recesses formed in a facial surface of the bezel. The wristwatch can include a plurality of spherical elements, wherein each spherical element is disposed in a respective semispherical recess, and a plurality of inner false prongs formed on the bezel and disposed along an inner circumference of the bezel between pairs of semispherical recesses. The wristwatch can further include a plurality of outer false prongs formed on the bezel and disposed along an outer circumference of the bezel between pairs of semispherical recesses and in radial alignment with corresponding inner false prongs.

### FIELD

This application relates generally to wristwatches and, more particularly, to a wristwatch with hybrid flush mount bezel having false prongs.

### SUMMARY

Some implementations can include a wristwatch comprising a case having a bezel, and a plurality of semispherical recesses formed in a facial surface of the bezel. The wristwatch can include a plurality of spherical elements, wherein each spherical element is disposed in a respective semispherical recess, and a plurality of inner false prongs formed on the bezel and disposed along an inner circumference of the bezel between pairs of semispherical recesses. The wristwatch can further include a plurality of outer false prongs formed on the bezel and disposed along an outer circumference of the bezel between pairs of semispherical recesses and in radial alignment with corresponding inner false prongs.

The semispherical recesses can be distributed evenly around the bezel (e.g., distributed evenly with respect to radial placement). The bezel can include an angled top surface sloping from a first level at an inner circumference down to a second level at an outer circumference.

The plurality of spherical elements can include 48 spherical elements. Each spherical element can be about 1.8 mm in diameter. Each semispherical recess can have a depth of about 0.9 mm. Each spherical element can be secured in a corresponding semispherical recess using an adhesive.

### BRIEF DESCRIPTION OF THE DRAWINGS

FIG. 1 is a front (or facial) view of an example wristwatch with hybrid flush mount bezel having false prongs in accordance with some implementations.

FIG. 2 is a side view of the example wristwatch with hybrid flush mount bezel having false prongs in accordance with some implementations.

FIG. 3 is a cutaway view of the example wristwatch with hybrid flush mount bezel having false prongs in accordance with some implementations.

FIG. 4 is an enlarged view of section A from FIG. 3.

FIG. 5 is a front (or facial) view of an example wristwatch with hybrid flush mount bezel having false prongs in accordance with some implementations.

### DETAILED DESCRIPTION

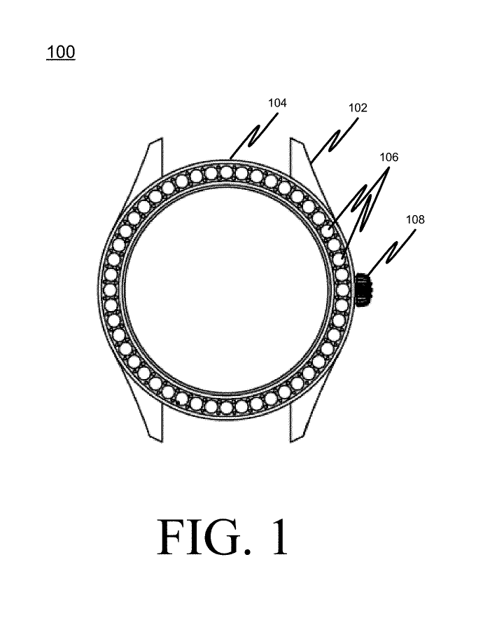

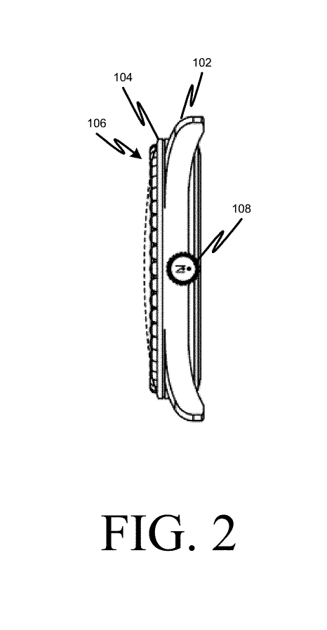

FIGS. 1 and 2 show an example wristwatch 100. The wristwatch 100 includes a case 102 with a hybrid flush mount bezel 104 having a plurality of spherical elements 106, and a crown 108. A round case 102 is shown for illustration purposes. It will be appreciated that some implementations can include a case having a shape other than round, such as rectangular, square, oval, polygonal, etc.

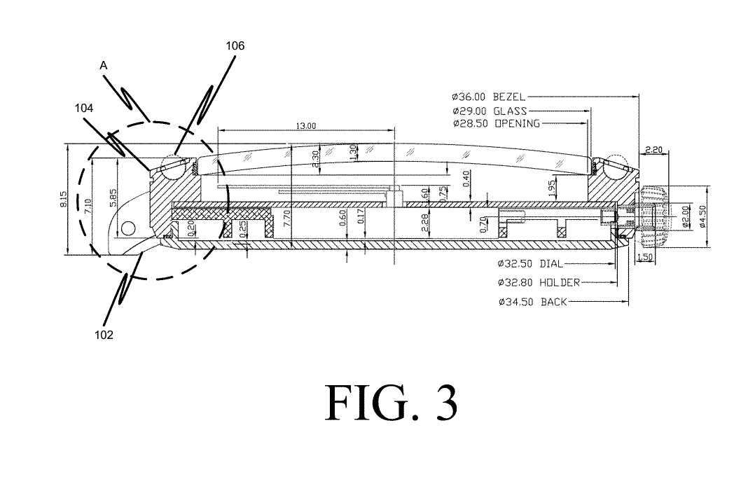

FIG. 3 is a cutaway view of the example wristwatch a case 102 and a hybrid flush mount bezel 104, and a plurality of spherical elements 106.

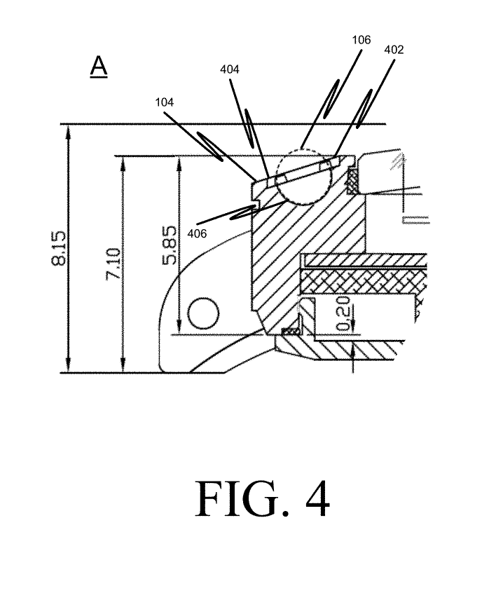

FIG. 4 is an enlarged view of section A from FIG. 3. As shown in enlarged section A, the bezel 104 has a plurality of spherical elements 106 mounted in semispherical recesses 406. In between each pair of spherical elements are an inner false prong 402 and an outer false prong 404.

The spherical elements 106 can include a spherical crystal having a coating applied (e.g., a nacre or nacre-like coating, such as paint, applied to a crystalline sphere). The spherical elements 106 can include a natural pearl, a freshwater pearl, a metallic sphere, a plastic sphere, a gemstone sphere, glass sphere, crystal sphere, etc. While the spherical elements 106 are described as spherical it will be appreciated that the spherical elements can include elements that are generally spherical in shape, or have natural variance, and not necessarily limited to elements that are perfectly spherical. In general the spherical elements 106 can be made from any material suitable for use on a wristwatch. The spherical elements 106 can be about 1.8 mm in diameter, for example. It will be appreciated that other spherical element sizes can be used.

The semi-spherical recesses 406 can be about 0.9 mm in depth (as measured from the front or facial surface of the bezel to the deepest point of the recess). The spherical elements 106 can be attached to the semi-spherical recesses using an adhesive. It will be appreciated that other suitable mounting techniques can be used.

FIGS. 3 and 4 also show the bezel 104, which has a sloping top (or facial) surface that slopes from a first, higher level at an inner circumference to a lower, second level at an outer circumference. The inner false prongs 402 and outer false prongs 404 follow the slope of the bezel 104.

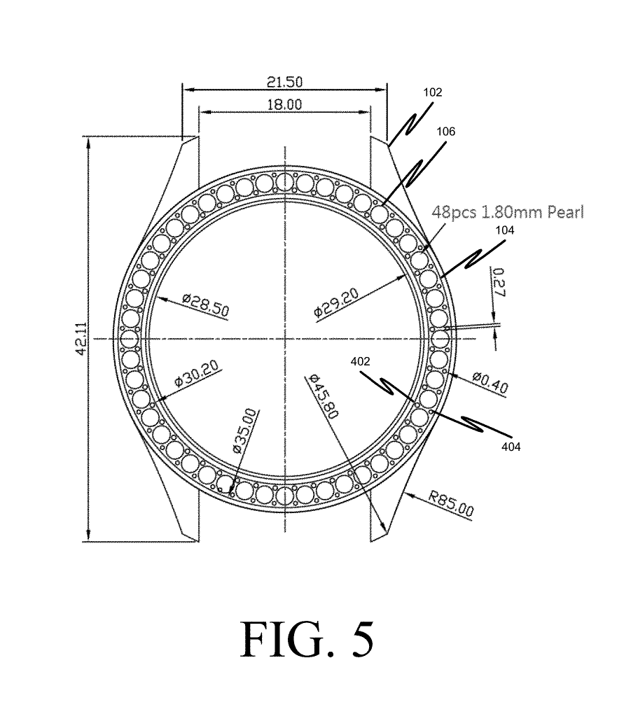

FIG. 5 is a front (or facial) view of an example wristwatch including a case 102 with a hybrid flush mount bezel 104 with a plurality of spherical elements 106 having false prongs (402, 404) in accordance with some implementations. In some implementations, the plurality of spherical elements 106 can include 48 spherical elements. In some implementations, each spherical element can be about 1.8 mm in diameter. In some implementations, each semispherical recess can have a depth of about 0.9 mm. It will be appreciated that implementations can include a different number of spherical elements of different sizes with semi-spherical recesses formed in a size corresponding to the size of the spherical elements.

It is, therefore, apparent that there is provided, in accordance with the various embodiments disclosed herein, a wristwatch with hybrid flush mount bezel having false prongs.

While the disclosed subject matter has been described in conjunction with a number of embodiments, it is evident that many alternatives, modifications and variations would be, or are, apparent to those of ordinary skill in the applicable arts. Accordingly, Applicant intends to embrace all such alternatives, modifications, equivalents and variations that are within the spirit and scope of the disclosed subject matter.

What is claimed is:

1. A wristwatch comprising:
a case having a bezel;
a plurality of semispherical recesses formed in a facial surface of the bezel;
a plurality of spherical elements, wherein each spherical element is disposed in a respective semispherical recess;
a plurality of inner false prongs formed on the bezel and disposed along an inner circumference of the bezel between pairs of semispherical recesses; and
a plurality of outer false prongs formed on the bezel and disposed along an outer circumference of the bezel between pairs of semispherical recesses and in radial alignment with corresponding inner false prongs.

2. The wristwatch of claim 1, wherein the semispherical recesses are distributed evenly around the bezel.

3. The wristwatch of claim 1, wherein the bezel has an angled top surface sloping from a first level at an inner circumference down to a second level at an outer circumference.

4. The wristwatch of claim 1, wherein the plurality of spherical elements includes 48 spherical elements.

5. The wristwatch of claim 1, wherein each spherical element is about 1.8 mm in diameter.

6. The wristwatch of claim 1, wherein each semispherical recess has a depth of about 0.9 mm.

7. The wristwatch of claim 1, wherein each spherical element is secured in a corresponding semispherical recess using an adhesive.
